(19) United States
(12) Patent Application Publication
(10) Pub. No.: US 2023/0076999 A1
(43) Pub. Date: Mar. 9, 2023

(54) TIME MANAGEMENT SYSTEM, TIME MANAGEMENT METHOD, AND RECORDING MEDIUM

(71) Applicant: NEC Corporation, Minato-ku, Tokyo (JP)

(72) Inventor: Kazuki Inagaki, Tokyo (JP)

(73) Assignee: NEC Corporation, Minato-ku, Tokyo (JP)

(21) Appl. No.: 17/798,121

(22) PCT Filed: Feb. 9, 2021
(86) PCT No.: PCT/JP2021/004805

§ 371 Date: Aug. 8, 2022

(30) Foreign Application Priority Data
Mar. 5, 2020 (JP) 2020-037533

(51) Int. Cl. G06Q 10/06; G07C 5/02

(52) U.S. Cl. CPC G06Q 10/06; G07C 5/02

(57) ABSTRACT

A time management system according to the present invention includes: a memory; and at least one processor coupled to the memory. The processor performs operations. The operations include: acquiring driver information including at least one of an image of a driver and information calculated based on the image of the driver, calculating a driving time of the driver, and generating driving information including the driver information and the driving time.

### TECHNICAL FIELD

The present invention relates to processing of information, and particularly to processing of information related to time, and the like.

### BACKGROUND ART

Generally, companies that employ employees need to manage their work hours to comply with laws and regulations (for example, the Labor Standards Act).

Management of working hours (driving time) of a driver of a vehicle such as a bus, a truck, or a taxi generally uses an operation recorder (tachograph or drive recorder) mounted on the vehicle in many cases. For example, the following management is performed on a daily basis.

After the end of driving, the driver creates a daily report based on a record result of an operation recorder, and submits the created daily report to a predetermined department (for example, work management department) of the company.

A person in charge of the management department aggregates the driving time in the daily report created by the driver for each predetermined period (for example, each week or each month), and calculates total driving time of each driver. Then, the person in charge of the management department manages the work state (for example, a driving time or the like) of the driver by using a predetermined standard (for example, a driving management time recommended or specified by a law) and the total driving time.

In addition, in recent years, the size and price of an imaging device such as a camera have become reasonable. Therefore, events during driving are managed using a camera (see, for example, PTLs 1 to 3).

The driving condition monitoring device described in PTL 1 stores a face image of a driver in association with a predetermined event such as sudden acceleration.

The driver identification system described in PTL 2 acquires driver information using biometric authentication in response to a predetermined event such as seating, door lock, or start of traveling, and identifies a driver associated to the acquired event.

The determination device described in PTL 3 determines whether a driver is an authorized driver by using a face image.

### CITATION LIST

### Patent Literature

[PTL 1]: JP 2019-128849 A

[PTL 2]: JP 2015-071319 A

[PTL 3]: WO 2018/043100 A

### SUMMARY OF INVENTION

### Technical Problem

The storing of the face image of the driver associated with a specific event such as exceeding the speed limit is effective from the viewpoint of investigating a cause of an accident that has occurred.

However, in order to prevent occurrence of an accident or the like in advance, it is necessary to manage a driving time in a predetermined period in addition to an individual event.

However, the techniques disclosed in PTLs 1 and 2 associate an individual event with a driver. The technique disclosed in PTL 3 is simply to determine the driver.

As described above, the techniques disclosed in PTLs 1 to 3 do not monitor an operation in a predetermined period such as a driving time.

In addition, in a method in which a driver creates a daily report based on a result of an operation recorder, which is generally performed, it is difficult to prevent falsification of a driving time by the driver since work by the driver is required.

An object of the present invention is to provide a management system that solves the above issues and generates information for managing a driving time of a driver without involving the driver.

### Solution to Problem

A time management system according to an aspect of the present invention includes: a driver information acquisition means for acquiring driver information including at least one of an image of a driver and information calculated based on the image of the driver, a driving time calculation means for calculating a driving time of the driver, and a driving information generation means for generating driving information including the driver information and the driving time.

A time management method in an aspect of the present invention includes acquiring driver information including at least one of an image of a driver and information calculated based on the image of the driver, calculating a driving time of the driver, and generating driving information including the driver information and the driving time.

A recording medium according to an aspect of the present invention records a program for causing a computer to execute: a process of acquiring driver information including at least one of an image of a driver and information calculated based on the image of the driver, a process of calculating a driving time of the driver, and a process of generating driving information including the driver information and the driving time.

### Advantageous Effects of Invention

According to the present invention, it is possible to achieve an effect of generating information for managing a driving time without involving a driver.

### BRIEF DESCRIPTION OF DRAWINGS

FIG. 1 is a block diagram illustrating an example of a configuration of a time management system according to a first example embodiment.

FIG. 2 is a flowchart illustrating an example of an operation of the time management system according to the first example embodiment.

FIG. 3 is a block diagram illustrating an example of a configuration of a main part of the time management system according to the first example embodiment.

FIG. 4 is a block diagram illustrating an example of a configuration of a time management system according to a third example embodiment.

FIG. 5 is a block diagram illustrating an example of a hardware configuration of a vehicle-mounted device.

### EXAMPLE EMBODIMENT

Next, an example embodiment of the present invention will be described with reference to the drawings.

Each drawing is for describing an example embodiment of the present invention. However, the present invention is not limited to the description of each drawing. Similar configurations in the drawings are denoted by the same reference numerals, and repeated description thereof may be omitted. In addition, in the drawings used in the following description, the description of portions not related to the description of the present invention may be omitted and not illustrated.

The following description of each example embodiment will be given using the driving time of the vehicle. However, this does not limit each example embodiment to the driving time of the vehicle.

each example embodiment can manage not only the driving time of the vehicle but also the operation in which a person to be managed continuously works for a certain period of time, such as an operation time for operating machine tools.

That is, in the following description of each example embodiment, “driving” is an example of “work” related to business. The “vehicle” is an example of a work target.

In the following description, the configuration included in each example embodiment is divided into a configuration included in a device mounted on a vehicle and a configuration included in a device installed in an office or the like. However, this configuration is for describing the example embodiment, and is an example of arrangement of the configuration. The arrangement of the configuration according to each example embodiment is not limited thereto.

For example, all the configurations may be included in one device. Alternatively, the configuration for achieving each example embodiment may be arranged in three or more devices.

### FIRST EXAMPLE EMBODIMENT

Hereinafter, a first example embodiment will be described with reference to the drawings.

[Description of Configuration]

First, a configuration of a time management system 10 according to the first example embodiment will be described with reference to the drawings.

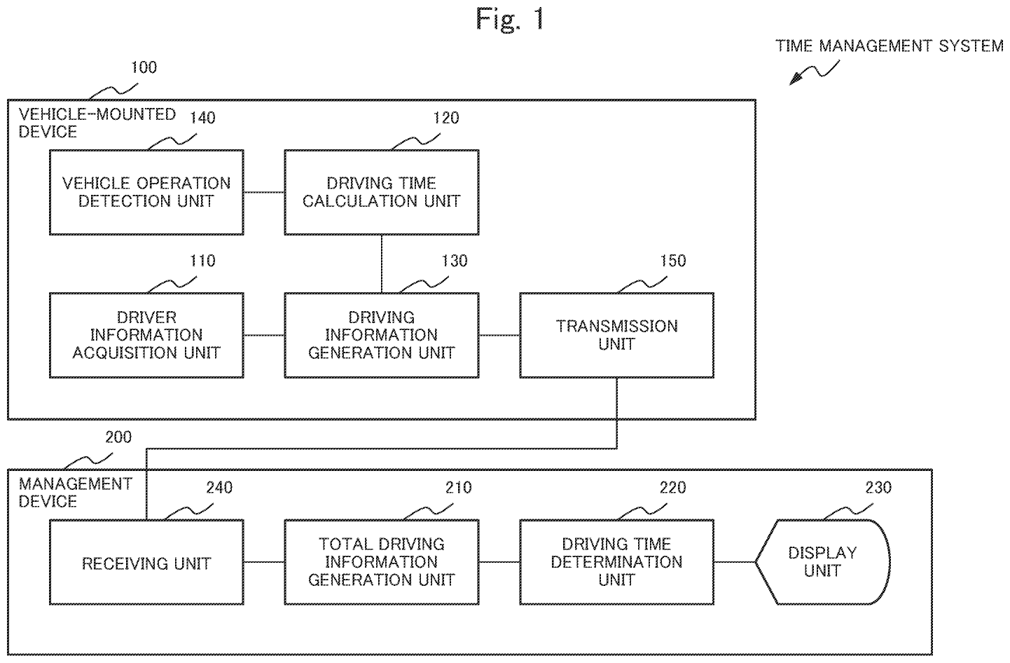

FIG. 1 is a block diagram illustrating an example of a configuration of the time management system 10 according to the first example embodiment.

The time management system 10 includes a vehicle-mounted device 100 and a management device 200.

The vehicle-mounted device 100 is mounted on a vehicle driven by a driver. However, the vehicle-mounted device 100 may not be fixedly mounted on the vehicle. For example, the vehicle-mounted device 100 may be implemented using a device carried by the driver. In this case, the vehicle-mounted device 100 may be implemented by using a vehicle operation detection unit 140 described later as a separate device.

Then, the vehicle-mounted device 100 generates driver information including at least one of an image of the driver and information related to the image (for example, a feature amount calculated based on the image) and driving information including a driving time. The driver information includes information that can uniquely identify the driver, such as an image of the driver. Therefore, the driving time associated with the driver information to be described later and the total driving time aggregated for each of pieces of driver information are the driving time and the total driving time of the driver related to the driver information. Therefore, in the following description, a term “driver” may be simply used instead of “driver information”.

Then, the vehicle-mounted device 100 transmits the generated driving information to the management device 200.

Any method may be used for transmitting the driving information generated by the vehicle-mounted device 100 to the management device 200. In the following description, as one example, an example in which the vehicle-mounted device 100 transmits driving information to the management device 200 by using a predetermined communication means will be described. However, the time management system 10 may use other methods.

For example, the vehicle-mounted device 100 may store the generated driving information in a storage device (not illustrated, for example, a universal serial bus (USB) memory). In this case, the management device 200 may read the driving information stored in the storage device (for example, the USB memory).

Alternatively, when the vehicle-mounted device 100 is a device carried by the driver, the driver may physically connect the vehicle-mounted device 100 to the management device 200.

The management device 200 is installed at a predetermined place (for example, a management office or a garage), and acquires driving information generated by the vehicle-mounted device 100. However, the management device 200 may be implemented using a means that is not fixed to a hardware device such as a system using a cloud computer.

Then, the management device 200 aggregates the driving time in a predetermined period (for example, month or week) for each of pieces of driver information, and calculates the total driving time for each of pieces of driver information. That is, the management device 200 calculates the total driving time for each driver.

The management device 200 compares a predetermined standard (for example, a driving management time recommended or specified by a law) with the total driving time, and outputs a comparison result (for example, a driver whose total driving time exceeds a reference).

Note that the management device 200 may calculate and output a difference from the reference (for example, a difference between the driving management time and the total driving time).

Next, a detailed configuration of each device will be described with reference to FIG. 1.

The vehicle-mounted device 100 includes a driver information acquisition unit 110, a driving time calculation unit 120, a driving information generation unit 130, a vehicle operation detection unit 140, and a transmission unit 150.

The vehicle operation detection unit 140 detects an operation related to the vehicle driven by the driver. For example, the vehicle operation detection unit 140 detects an operation of the vehicle (for example, start and stop of movement), an operation of a driving engine such as an engine or a motor (for example, start and stop of rotation), and the like, and notifies the driving time calculation unit 120 of the detected operation.

The vehicle operation detection unit 140 is not limited to a device that detects an individual event. For example, the vehicle operation detection unit 140 may be an operation recorder.

The driving time calculation unit 120 calculates the driving time by using the operation related to the vehicle detected by the vehicle operation detection unit 140.

For example, when the vehicle operation detection unit 140 detects an event such as movement start or stop in the vehicle, the driving time calculation unit 120 may measure a time from the movement start time to the stop time of the vehicle by using a clocking device (not illustrated) and use the measured time as the driving time. Alternatively, when the vehicle operation detection unit 140 is an operation recorder, the driving time calculation unit 120 may acquire the time recorded in the operation recorder as the driving time.

The operation used by the driving time calculation unit 120 to calculate the driving time is not limited to the operation in which the vehicle actually moves. For example, the driving time calculation unit 120 may use insertion and removal of a key used to start the vehicle or opening and closing of a door of the vehicle. Alternatively, the driving time calculation unit 120 may use an operation related to movement of the vehicle, such as movement of a shift lever and a change in the position of a pedal such as an accelerator.

Then, the driving time calculation unit 120 transmits the generated driving time to the driving information generation unit 130.

The driving time calculation unit 120 may transmit time information related to driving, such as a driving start date and time and/or a driving end date and time, in addition to the driving time.

The driver information acquisition unit 110 acquires an image of the driver and/or information related to the image (for example, a feature amount). In the following description, a “feature amount” is used as information related to the image. The image and the feature amount may be collectively referred to as an “image or the like”.

Any device for acquiring an image of a driver or the like may be used. For example, the driver information acquisition unit 110 may include a camera and directly acquire the image of the driver. Alternatively, the driver information acquisition unit 110 may acquire an image of the driver captured by an imaging device (not illustrated) in the vehicle.

When the driver information acquisition unit 110 uses the feature amount, any configuration for calculating the feature amount may be used. For example, the driver information acquisition unit 110 may calculate the feature amount from the image. Alternatively, the imaging device may calculate the feature amount and transmit the feature amount to the driver information acquisition unit 110. Alternatively, a configuration (not illustrated) may calculate the feature amount from the image.

Then, the driver information acquisition unit 110 transmits driver information including the acquired image of the driver and the like to the driving information generation unit 130.

The driver information acquisition unit 110 may transmit the driver information at any timing. The driver information acquisition unit 110 may transmit the driver information at a predetermined cycle. Alternatively, the driver information acquisition unit 110 may acquire and transmit the driver information in response to a request from the driving information generation unit 130.

Alternatively, the driver information acquisition unit 110 may acquire the driver information on the basis of a predetermined condition. For example, the driver information acquisition unit 110 may have a function of determining a person in the acquired image, and may transmit the driver information when it is determined that the image includes a person (for example, in a case where a driver is seated in a driver's seat). Further, the driver information acquisition unit 110 may transmit the driver information when detecting a change of a person in addition to the detection of a person.

Any method of determining a person included in the image may be used. For example, the driver information acquisition unit 110 may determine a person by comparing a feature amount of the acquired image with a feature amount stored in advance. Alternatively, the driver information acquisition unit 110 may determine a person using predetermined machine learning or artificial intelligence.

Further, the driver information may include information other than the image of the driver.

For example, when the driver inputs his/her identification information (for example, an employee number) at the start of driving, the driver information acquisition unit 110 may include an identification number in the driver information.

Note that, in general, the feature amount of the image is smaller in volume of data than the original image. Therefore, when the feature amount is used, the driver information has a smaller amount of data than when the image is used. Therefore, when the feature amount is used, a capacity for storing the driver information and a communication load can be reduced.

Alternatively, the driver information acquisition unit 110 may include both the image of the driver and the feature amount of the image in the driver information.

In this manner, the driver information acquisition unit 110 acquires driver information including at least one of the image of the driver and the information calculated based on the image of the driver.

The driving information generation unit 130 generates driving information including driver information and the driving time.

The driving information generation unit 130 may generate driving information for each driver.

As an example, a case where the driver information acquisition unit 110 detects a change of the driver will be described.

When detecting the driver, the driver information acquisition unit 110 transmits the driver information. Further, when detecting the change of the driver, the driver information acquisition unit 110 transmits the changed driver information. Then, the driving time calculation unit 120 calculates the driving time including the driving start date and time.

In this case, the driving information generation unit 130 stores the time when the driver information is received from the driver information acquisition unit 110. Then, the driving information generation unit 130 divides the driving time acquired from the driving time calculation unit 120 by the time when the driver information is received, and generates driving information including the driver information and the driving time relevant to each divided time.

However, the driving information generation unit 130 may generate driving information related to a plurality of drivers. In this case, the driving information generation unit 130 generates driving information including each piece of driver information and a driving time in association with each other.

Furthermore, the driver may drive while taking a break. Therefore, the driving information generation unit 130 may generate driving information including a plurality of driving information related to the same driver or a plurality of driving times related to the same driver.

When the driving time calculation unit 120 outputs other time information related to driving such as a start date and time and an end date and time of driving in addition to the driving time, the driving information generation unit 130 may include the information in the driving time.

The transmission unit 150 transmits the driving information generated by the driving information generation unit 130 to the management device 200.

Note that the vehicle-mounted device 100 cannot always transmit driving information to the management device 200. For example, in a case where the vehicle-mounted device 100 and the management device 200 communicate wirelessly, communication may not be possible.

Therefore, the vehicle-mounted device 100 may store the driving information in a storage unit (not illustrated) and transmit the driving information when communication with the management device 200 becomes possible.

The management device 200 includes a total driving information generation unit 210, a driving time determination unit 220, a display unit 230, and a receiving unit 240.

The receiving unit 240 acquires driving information from the vehicle-mounted device 100. The receiving unit 240 may store the received driving information in a storage unit (not illustrated).

The total driving information generation unit 210 aggregates the driving time for each of pieces of driver information by using the driver information included in the driving information, and calculates the total driving time for each of pieces of driver information (that is, for each driver). Then, the total driving information generation unit 210 generates total driving information including the calculated total driving time and the driver information.

In a case where the driving information includes the start time and the end time of driving, the total driving information generation unit 210 may generate time-series information related to the operation by using the time information. For example, the total driving information generation unit 210 may store the history of the driving information by using the start time and the end time.

Alternatively, for example, the total driving information generation unit 210 may calculate an average driving time for each day using the earliest start date and time and the latest end date and time in the driving time included in the total driving time, and include the calculated average driving time in the total driving information.

The total driving information generation unit 210 may store the generated total driving information in a storage unit (not illustrated).

Although not illustrated, the system that manages the driver may execute other processing (for example, payroll processing) using the total driving time included in the generated total driving information.

The driving time determination unit 220 determines whether the total driving time included in the total driving information exceeds a predetermined standard (for example, a driving management time recommended or specified by a law).

Then, the driving time determination unit 220 outputs the determination result to a predetermined device (for example, a driving management device of the driver) or stores the determination result in a predetermined storage device.

The driving time determination unit 220 may use the driver information included in the total driving information as an output destination of the determination result. For example, the driving time determination unit 220 may output the determination result to the driver using the driver information. Alternatively, the driving time determination unit 220 may output the determination result to a supervisor of the driver by using organization information in the company in addition to the driver information.

Note that the time management system 10 includes a display unit 230 as an example of an output destination of the determination result. The driving time determination unit 220 transmits the determination result to the display unit 230.

The display unit 230 displays a result determined by the driving time determination unit 220. For example, the display unit 230 displays the total driving time determined to exceed the predetermined standard and the driver information associated to the determined total driving time, in association with each other. For example, when the driver information includes the image of the driver, the display unit 230 may display the image of the driver and the determination result (for example, whether the driving management time exceeds a driving management time recommended or specified by a law) in association with each other.

The display unit 230 may display the determination result in association with other information.

Furthermore, the display unit 230 may display information other than the image of the driver and the determination result, such as the total driving time.

Note that the display unit 230 may display part of the total driving information on the basis of the determination result in the driving time determination unit 220. For example, the display unit 230 may display the driver information included in the total driving information in which the total driving time per month exceeds a predetermined standard (for example, a driving management time recommended or specified by a law).

Alternatively, the display unit 230 may be connected to an input device (not illustrated) and select the total driving information to be displayed on the basis of a condition designated via the input device.

As described above, the time management system 10 generates the driving information including the driver information and the driving time without requiring the input of the driver. The driving information is information used to manage the driving time of the driver.

That is, the time management system 10 generates information (driving information) for managing the driving time without involving the driver.

In addition, the time management system 10 calculates the total driving time without requiring manpower.

Therefore, the time management system 10 reduces man-hours for aggregating the driving time in the management department or the like.

[Description of Operation]

Next, an operation of the time management system 10 according to the first example embodiment will be described with reference to the drawings.

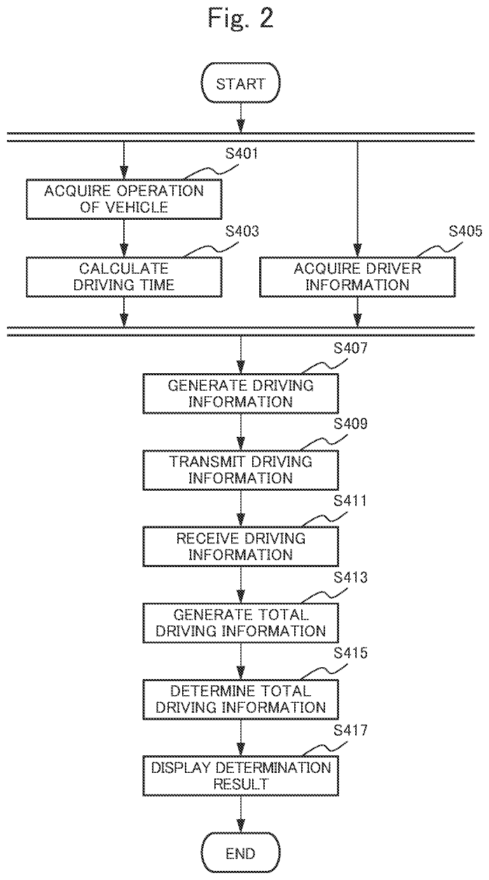

FIG. 2 is a flowchart illustrating an example of an operation of the time management system 10 according to the first example embodiment.

The vehicle operation detection unit 140 detects an operation of the vehicle (step S401).

The driving time calculation unit 120 calculates driving time by using the operation of the vehicle (step S403).

The driver information acquisition unit 110 acquires driver information (step S405).

Note that the driving time calculation unit 120 and the driver information acquisition unit 110 may operate in parallel at least in part.

The driving information generation unit 130 generates driving information including the driver information and the driving time (step S407).

The transmission unit 150 transmits the driving information to the management device 200 (step S409).

The receiving unit 240 receives the driving information (step S411).

The total driving information generation unit 210 calculates the total driving time for each of pieces of driver information by using the driving information, and generates the total driving information including the driver information and the total driving time (step S413).

The driving time determination unit 220 determines whether the total driving time included in the total driving information satisfies a predetermined condition (step S415).

The display unit 230 displays the determination result (step S417).

[Description of Effects]

Next, effects of the time management system 10 according to the first example embodiment will be described.

The time management system 10 according to the first example embodiment can obtain an effect of generating information for managing the driving time without involving the driver.

The reason is as follows.

The time management system 10 includes a driver information acquisition unit 110, a driving time calculation unit 120, and a driving information generation unit 130. The driver information acquisition unit 110 acquires driver information including at least one of an image of a driver and information calculated based on the image of the driver. The driving time calculation unit 120 calculates the driving time of the driver. The driving information generation unit 130 generates driving information including driver information and the driving time.

The driving information includes driver information for identifying the driver and a driving time related to the driver information. Further, the driving time is information used for managing the driving time by the driver. The time management system 10 does not require work of the driver to generate the driving information. As described above, the time management system 10 generates information for managing the driving time without involving the driver.

Further, the time management system 10 includes a total driving information generation unit 210. The total driving information generation unit 210 generates total driving information including a total driving time, which is a total of driving times in a predetermined period and driver information by using driving information in the predetermined period.

The total driving information is information that can be used for managing the driving time of the driver. The time management system 10 does not require manpower for generation of the total driving information. In this manner, the time management system 10 reduces man-hours for aggregating the driving time in the management department or the like.

The time management system 10 further includes a driving time determination unit 220 and a display unit 230.

The driving time determination unit 220 determines whether the total driving time included in the total driving information exceeds a predetermined standard (for example, a driving management time recommended or specified by a law). The display unit 230 displays the determination result. For example, the display unit 230 displays the total driving time determined to exceed the driving management time and the driver information associated to the determined total driving time.

Therefore, a user of the time management system 10 can specify a driver who exceeds a predetermined standard (for example, a driving management time recommended or specified by a law) in a predetermined period.

Further, the time management system 10 includes a vehicle operation detection unit 140. The vehicle operation detection unit 140 detects an operation of the vehicle driven by the driver. Then, the driving time calculation unit 120 calculates the driving time using the detected operation of the vehicle.

Therefore, the time management system 10 can provide a driving time according to the operation of the vehicle.

Note that the driver information acquisition unit 110 may detect a change of the driver. For example, the driver information acquisition unit 110 may detect the change of the driver by using an image of the driver.

Then, the driving information generation unit 130 may generate the driving information by using the detected change of the driver. In this case, the time management system 10 can provide the driving information and the total driving information according to the change of the driver to the user of the system.

### SECOND EXAMPLE EMBODIMENT

Next, an outline of the first example embodiment will be described as a second example embodiment.

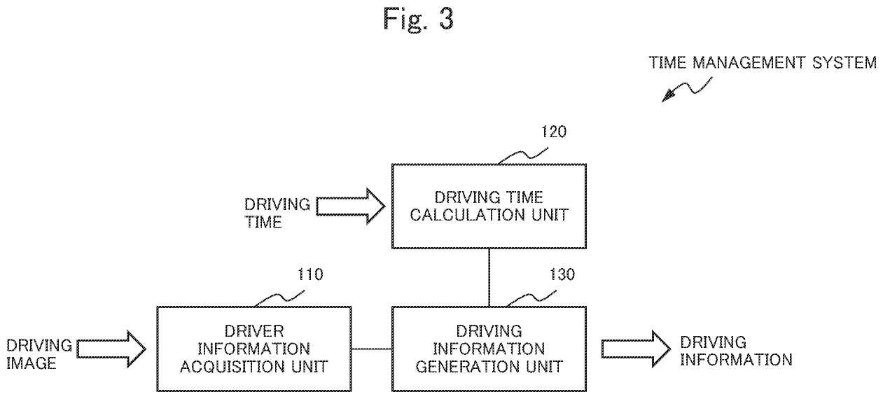

FIG. 3 is a block diagram illustrating an example of a configuration of a time management system 11, which is a main part of the time management system 10 according to the first example embodiment.

The time management system 11 includes a driver information acquisition unit 110, a driving time calculation unit 120, and a driving information generation unit 130. The driver information acquisition unit 110 acquires driver information including at least one of an image of a driver and information calculated based on the image of the driver. The driving time calculation unit 120 calculates the driving time of the driver. The driving information generation unit 130 generates driving information including driver information and the driving time.

The driving information includes driver information for identifying the driver and a driving time related to the driver information. The time management system 11 does not require work of the driver to generate the driving time.

As described above, similarly to the time management system 10, the time management system 11 has an effect of generating information (driving information) for managing the driving time without involving the driver.

The time management system 11 is also the minimum configuration of the time management system 10.

### THIRD EXAMPLE EMBODIMENT

For example, a driver of a truck performs cargo handling work other than driving of the truck. The cargo handling work is not work of driving a vehicle. However, since the cargo handling work is performed by the driver, the cargo handling work is related to fatigue of the driver and the like. That is, in addition to the driving time, work time that requires management may occur.

Therefore, as a third example embodiment, a time management system 12 that manages work other than driving will be described.

In the following description, cargo handling work will be used as work other than the driving. However, the work other than the driving is not limited to the cargo handling work. Any work other than the driving may be used in association with the third example embodiment. For example, as work other than driving, there are works related to a vehicle, such as an inspection work of a machine such as a vehicle, a fuel replenishing work, and a maintenance and cleaning work of a machine, in addition to the cargo handling work. Alternatively, as work other than driving, there are works that are not related to the vehicle, such as assistance of getting on and off of passengers in a bus, a taxi, or the like, and entry work of a slip associated with delivery and receipt of an article.

However, in the following description, cargo handling work will be used as an example of work other than driving.

Next, the third example embodiment will be described with reference to the drawings.

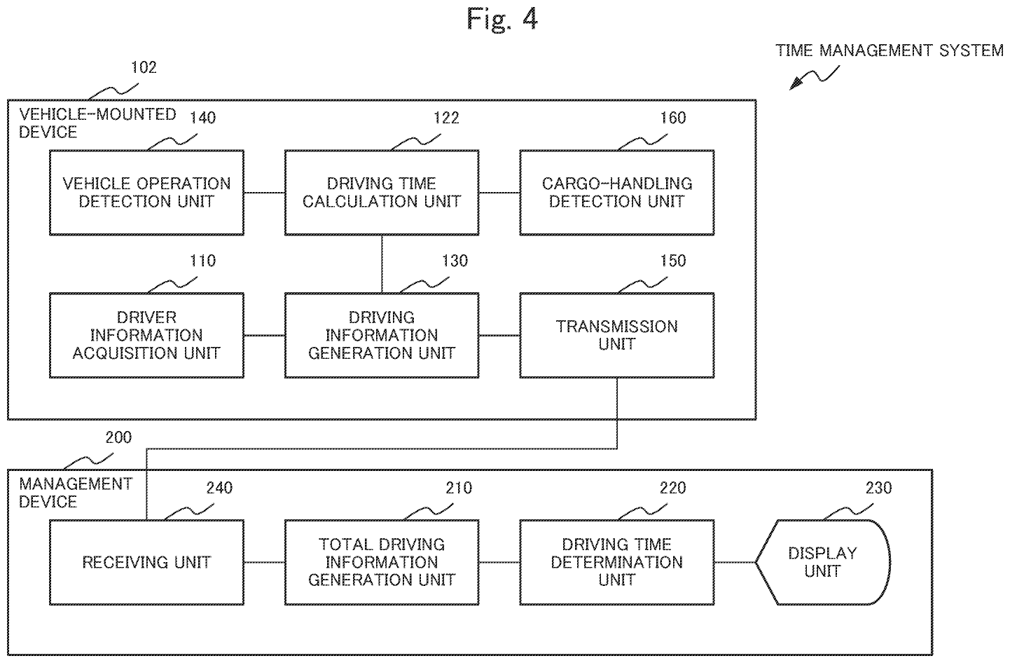

FIG. 4 is a block diagram illustrating an example of a configuration of the time management system 12 according to the third example embodiment.

Compared with the time management system 10, the time management system 12 includes a vehicle-mounted device 102 instead of the vehicle-mounted device 100. As compared with the vehicle-mounted device 100, the vehicle-mounted device 102 includes a driving time calculation unit 122 instead of the driving time calculation unit 120, and further includes a cargo-handling detection unit 160.

In the following description, a detailed description of the same configuration as that of the first example embodiment will be omitted, and a configuration specific to the third example embodiment will be described.

The cargo-handling detection unit 160 detects cargo handling work performed by a driver.

Any method of detecting the cargo handling work may be used.

For example, a large vehicle such as a truck is equipped with a camera that captures the surroundings in order to prevent a blind spot accident or the like. A general passenger vehicle is also equipped with a camera for monitoring the rear.

Therefore, the cargo-handling detection unit 160 may detect the cargo handling work of the driver by using an image of an imaging device that images the outside of the vehicle.

The driving time calculation unit 122 calculates, as cargo handling time, a time between the time when the cargo-handling detection unit 160 detects the start of the cargo handling work by the driver and the time when the cargo-handling detection unit 160 detects the end of the cargo handling work.

Then, the driving time calculation unit 122 adds the calculated cargo handling time to the driving time.

That is, the driving time calculation unit 122 sets a time obtained by adding the cargo handling time calculated based on the cargo handling work detected by the cargo-handling detection unit 160 to the driving time calculated based on the vehicle operation detected by the vehicle operation detection unit 140 as the driving time to be included in the driving information.

The cargo handling work is often performed without stopping the engine. Therefore, the driving time calculation unit 122 may refer to the operation of the vehicle detected by the vehicle operation detection unit 140 in the calculation of the cargo handling time.

However, the driving information used by the time management system 12 is not limited to the above. For example, the time management system 12 may separately manage a driving time for driving the vehicle and a work time associated with cargo handling or the like.

For example, the driving information generation unit 130 may generate driving information including a driving time and a work time associated with cargo handling or the like in a distinguishable manner. In this case, the total driving information generation unit 210 and the driving time determination unit 220 may separately process the driving time included in the driving information and the working time associated with cargo handling and the like.

Next, effects of the time management system 12 according to the third example embodiment will be described.

In addition to the effects of the first example embodiment, the time management system 12 according to the third example embodiment can obtain an effect of generating information used for management regarding work other than driving executed by a driver.

The reason is as follows.

The time management system 12 includes a cargo-handling detection unit 160 and a driving time calculation unit 122. The cargo-handling detection unit 160 detects the cargo handling work of the driver. The driving time calculation unit 122 calculates a driving time similarly to the driving time calculation unit 120, and further calculates a cargo handling time of the driver by using the detected cargo handling work, and adds the calculated cargo handling time to the driving time.

In this manner, the time management system 12 can generate information including work time related to the driver other than driving.

<Hardware Configuration>

Next, a hardware configuration of each example embodiment will be described using the vehicle-mounted device 100. Other devices can be implemented by using a hardware configuration similar to that of the vehicle-mounted device 100. Therefore, the description of other devices is omitted unless the other devices are particularly unique to the device.

Each component of the vehicle-mounted device 100 may be configured by a hardware circuit.

Alternatively, in the vehicle-mounted device 100, each component may be configured by using a plurality of devices connected via a network.

Alternatively, in the vehicle-mounted device 100, the plurality of components may be configured by one piece of hardware.

Alternatively, the vehicle-mounted device 100 may be implemented as a computer device including a central processing unit (CPU), a read only memory (ROM), and a random access memory (RAM). In addition to the above configuration, the vehicle-mounted device 100 may be implemented as a computer device including an input and output circuit (IOC). In addition to the above configuration, the vehicle-mounted device 100 may be implemented as a computer device including a network interface circuit (NIC).

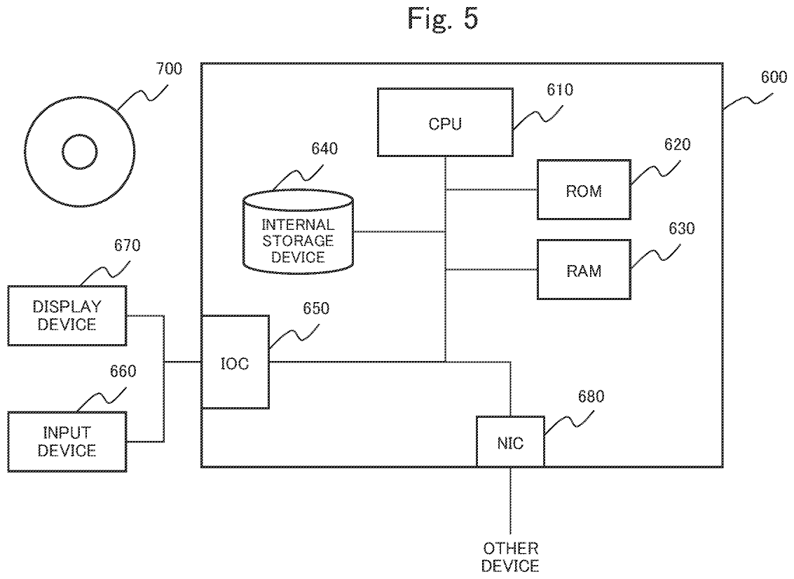

FIG. 5 is a block diagram illustrating a configuration of an information processing device 600, which is an example of a hardware configuration of the vehicle-mounted device 100.

The information processing device 600 includes a CPU 610, a ROM 620, a RAM 630, an internal storage device 640, an IOC 650, and an NIC 680, and constitutes a computer device.

The CPU 610 reads a program from the ROM 620 and/or the internal storage device 640. Then, the CPU 610 controls the RAM 630, the internal storage device 640, the IOC 650, and the NIC 680 on the basis of the read program. Then, the computer including the CPU 610 controls these configurations and enables functions as the driver information acquisition unit 110, the driving time calculation unit 120, the driving information generation unit 130, the vehicle operation detection unit 140, and the transmission unit 150 illustrated in FIG. 1.

When enabling the functions, the CPU 610 may use the RAM 630 or the internal storage device 640 as a temporary storage medium of the program.

The CPU 610 may read the program included in the storage medium 700 storing the program in a computer readable manner by using a storage medium reading device (not illustrated). Alternatively, the CPU 610 may receive a program from an external device (not illustrated) via the NIC 680, store the program in the RAM 630 or the internal storage device 640, and operate on the basis of the stored program.

The ROM 620 stores programs executed by the CPU 610 and fixed data. The ROM 620 is, for example, a programmable ROM (P-ROM) or a flash ROM.

The RAM 630 temporarily stores programs executed by the CPU 610 and data. The RAM 630 is, for example, a dynamic-RAM (D-RAM).

The internal storage device 640 stores data and programs to be stored for a long period of time by the information processing device 600. The internal storage device 640 may operate as a temporary storage device of the CPU 610. The internal storage device 640 is, for example, a hard disk device, a magneto-optical disk device, a solid state drive (SSD), or a disk array device.

The ROM 620 and the internal storage device 640 are non-transitory storage media. On the other hand, the RAM 630 is a transitory storage medium. The CPU 610 is operable based on a program stored in the ROM 620, the internal storage device 640, or the RAM 630. That is, the CPU 610 can operate using a non-transitory storage medium or a transitory storage medium.

The IOC 650 mediates data between the CPU 610, the input device 660, and the display device 670. The IOC 650 is, for example, an IO interface card or a universal serial bus (USB) card. Furthermore, the IOC 650 is not limited to using wired communication such as USB, and may use wireless communication.

The input device 660 is a device that receives an input instruction from an operator of the information processing device 600. The input device 660 is, for example, a keyboard, a mouse, or a touch panel.

The display device 670 is a device that displays information to an operator of the information processing device 600. The display device 670 is, for example, a liquid crystal display, an organic electroluminescence display, or electronic paper.

The information processing device 600 may include the input device 660 and/or the display device 670.

The NIC 680 relays exchange of data with an external device (not illustrated) via a network. The NIC 680 is, for example, a local area network (LAN) card or a wireless LAN adapter. As described above, the NIC 680 may use either wired or wireless communication.

The information processing device 600 configured as described above can obtain effects similar to those of the vehicle-mounted device 100.

The reason is that the CPU 610 of the information processing device 600 can enable a function similar to that of the vehicle-mounted device 100 on the basis of the program.

Although the present invention has been described above with reference to the example embodiments, the present invention is not limited to the above example embodiments. It will be understood by those of ordinary skill in the art that various changes in form and details may be made therein without departing from the spirit and scope of the present invention as defined by the claims.

This application is based upon and claims the benefit of priority from Japanese patent application 2020 037533, filed on Mar. 5, 2020, the disclosure of which is incorporated herein in its entirety by reference.

### REFERENCE SIGNS LIST

10 Time management system
11 Time management system
12 Time management system
100 Vehicle-mounted device
102 Vehicle-mounted device
110 Driver information acquisition unit
120 Driving time calculation unit
122 Driving time calculation unit
130 Driving information generation unit
140 Vehicle operation detection unit
150 Transmission unit
160 Cargo-handling detection unit
200 Management device
210 Total driving information generation unit
220 Driving time determination unit
230 Display unit
240 Receiving unit
600 Information processing device
610 CPU
620 ROM
630 RAM
640 Internal storage device
650 IOC
660 Input device
670 Display device
680 NIC
700 Storage medium

What is claimed is:

1-7. (canceled)

8. A time management method, comprising:
acquiring driver information including at least one of an image of a driver and information calculated based on the image of the driver;
calculating a driving time of the driver; and
generating driving information including the driver information and the driving time.

9. A non-transitory computer-readable recording medium embodying a program, the program causing a computer to perform a method, the method comprising:
acquiring driver information including at least one of an image of a driver and information calculated based on the image of the driver;
calculating a driving time of the driver; and
generating driving information including the driver information and the driving time.

10. A time management system comprising:
a memory; and
at least one processor coupled to the memory,
the processor performing operations, the operations comprising:
acquiring driver information including at least one of an image of a driver and information calculated based on the image of the driver;
calculating a driving time of the driver; and
generating driving information including the driver information and the driving time.

11. The time management system according to claim 10, wherein the operations further comprise:
generating, by using the driving information in a predetermined period, total driving information including a total driving time being an aggregation of the driving times in the predetermined period, and the driver information.

12. The time management system according to claim 11, wherein the operations further comprise:
determining whether the total driving time included in the total driving information exceeds a predetermined standard in the predetermined period; and
displaying the total driving time determined to exceed the predetermined standard and the driver information associated to the determined total driving time, in association with each other.

13. The time management system according to claim 10, wherein the operations further comprise:
detecting an operation of a vehicle driven by the driver, and
calculating the driving time by using the detected operation of the vehicle.

14. The time management system according to claim 10, wherein the operations further comprise:
detecting a change of the driver by using the image of the driver, and
generating the driving information by using the detected change of the driver.

15. The time management system according to claim 14, wherein the operations further comprise:
detecting the change of the driver and
acquiring the driver information based on the detected change.

16. The time management system according to claim 10, wherein the operations further comprise:
detecting a cargo handling work of the driver,
calculating a cargo handling time of the driver by using the detected cargo handling work, and
adding the cargo handling time to the driving time.
